(19) United States
(12) Patent Application Publication
(10) Pub. No.: US 2012/0087496 A1
(43) Pub. Date: Apr. 12, 2012

(54) HOME USE ACTIVE REMOTE ENCRYPTION AND SWITCHING DEVICE

(75) Inventors: CHUN LO, TAINAN COUNTY (TW); CHIN-TIEN LIN, TAINAN CITY (TW); SHIH-JUNG LIN, TAINAN CITY (TW); CHUN-HSIEN WU, TAINAN CITY (TW); CHENG-HSIN WU, TAINAN CITY (TW)

(73) Assignee: DA AR FA INTERNATIONAL CO., LTD., TAINAN CITY (TW)

(21) Appl. No.: 12/900,685

(22) Filed: Oct. 8, 2010

(51) Int. Cl. H04N 7/167

(52) U.S. Cl. 380/210; 348/14.02; 348/E07.077

(57) ABSTRACT

A home use active remote encryption and switching device is revealed. Transmission of remote images and information as well as switching of home appliances is controlled by wireless communication. The home use active remote encryption and switching device includes at least one video mobile phone with specific permission, a signal receiving interface receiving signals from the mobile phone, a digital signal processor that decrypts and modulates signals from the mobile phone, a central processing unit that integrates and converts decrypted signals into switching signals, and a storage device storing audio/video signals. Thereby signals from the video mobile phone are transmitted to the remote signal receiving interface by wireless communication equipments. Then the signals are decrypted by the digital signal processor, converted into switching signals by the central processing unit, and sent to home appliances. Thus remote switching of home appliances is achieved under the control of the video mobile phone.

### BACKGROUND OF THE INVENTION

1. Field of the Invention

The present invention relates to an active remote encryption and switching device, especially to a home use active remote encryption and switching device that uses video mobile phones to transmit signals through wireless communication equipments available now. The signals are sent to a remote signal receiving interface for being processed and transmitted. Thus on/off of home appliances is controlled. Therefore, the construction cost is reduced and energy saving and carbon reduction are achieved.

Now people from different social levels have paid more attention to the family safety issue. Along with busyness of family members and improved performance of home appliances, the importance of the maintenance and the safety monitoring of the home appliances has become more obvious. The family members may forget to turn off the home appliances, or turn on at specific time, Generally, the home appliances are on/off by manual operation. Or timers are used to turn on the appliances for a timed interval and the preset appliances need to be powered by electricity us this is a source of energy waste and a source of danger.

The prior arts of home safety monitoring are mainly based on wired or short distance wireless control connections. One of the most popular technical products is internet that plays an important role on the remote control. Conventional remote control service system uses personal computers (PC) as I/O Servers, which is a communication interface between I/O devices and the network. Such PC-based residential gateway design used in information appliance monitoring is a bit kind of wasting computer resources. Or the personal computer is used as a monitor mainframe that monitors a plurality of residential gateway. However, once the internet has connection problem or bandwidth problem, the monitored image transmission is interrupted or lossy, the monitoring fails. Thus such passive system is not convenient for use. At the same time, the wired transmission needs wires or cables as transmission media. The internet has shortcomings of high construction cost and complicated architecture.

### SUMMARY OF THE INVENTION

Therefore it is a primary object of the present invention to provide a home use active remote encryption and switching device with great popularity in which video mobile phones are used as a wireless communication platform. Moreover, users only need to have agreements with telecom service providers and there is no cost problem related to construction of wired telecom systems. The architecture of the present invention can achieve effective remote control and switching of home appliances so that the device is with high practical value.

In order to achieve the above object, a home use active remote encryption and switching device, which sends remote images and information as well as controls on/off of remote home appliances by wireless communication, includes at least one video mobile phone with specific permission, a signal receiving interface that receives signals from the video mobile phone, a digital signal processor that decrypts and modulates signals from the video mobile phone, a central processing unit that integrates and converts decrypted signals into switching signals, and a storage device that stores audio/video signals. By wireless communication equipments available now, signals from the video mobile phone are sent to the remote signal receiving interface. After being decrypted by the digital signal processor and converted into switching signals by the central processing unit, the signals are sent to home appliances so as to achieve active switching of home appliances under remote control of the mobile phone.

Moreover, the signal receiving interface has encryption settings and corresponds to at least one video mobile phone with permission. Thus there can be several mobile phones, each used by one family member.

Furthermore, the video mobile phone is a wireless mobile phone that supports at least 3G. 3G is a generation of standards used in mobile telecommunications and mobile phones, providing real-time and broadband services for audio video transmission.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of an embodiment according to the present invention;

FIG. 2 is a schematic drawing showing an embodiment of the present invention in use:

FIG. 3 is a schematic drawing showing another embodiment of the present invention in use.

### DETAILED DESCRIPTION OF THE PREFERRED EMBODIMENT

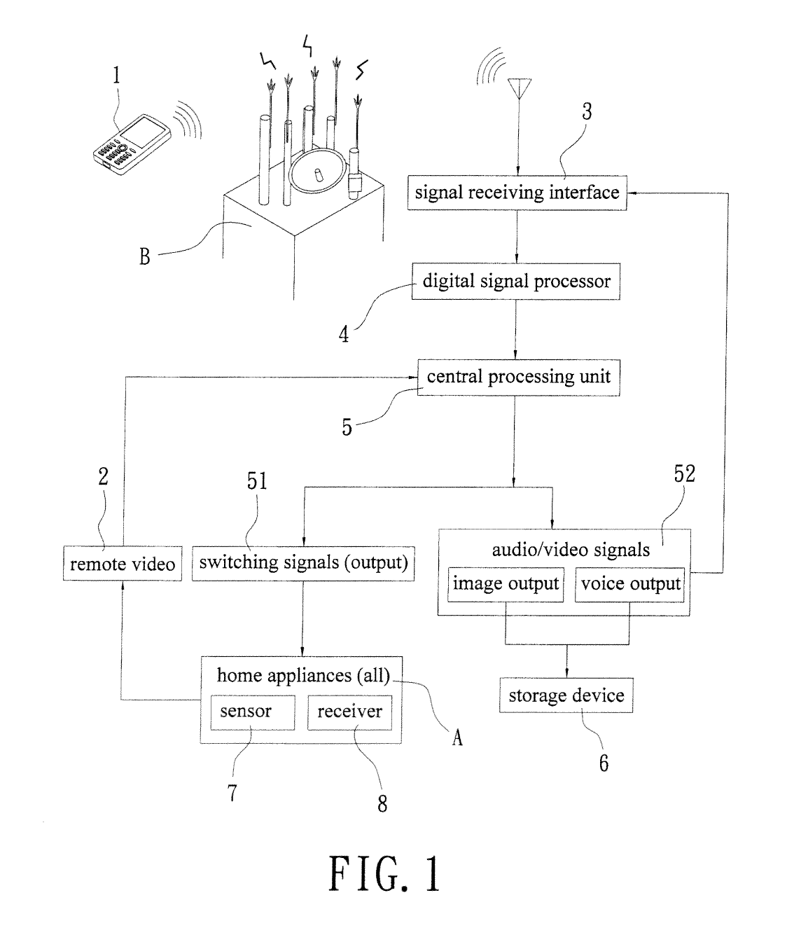

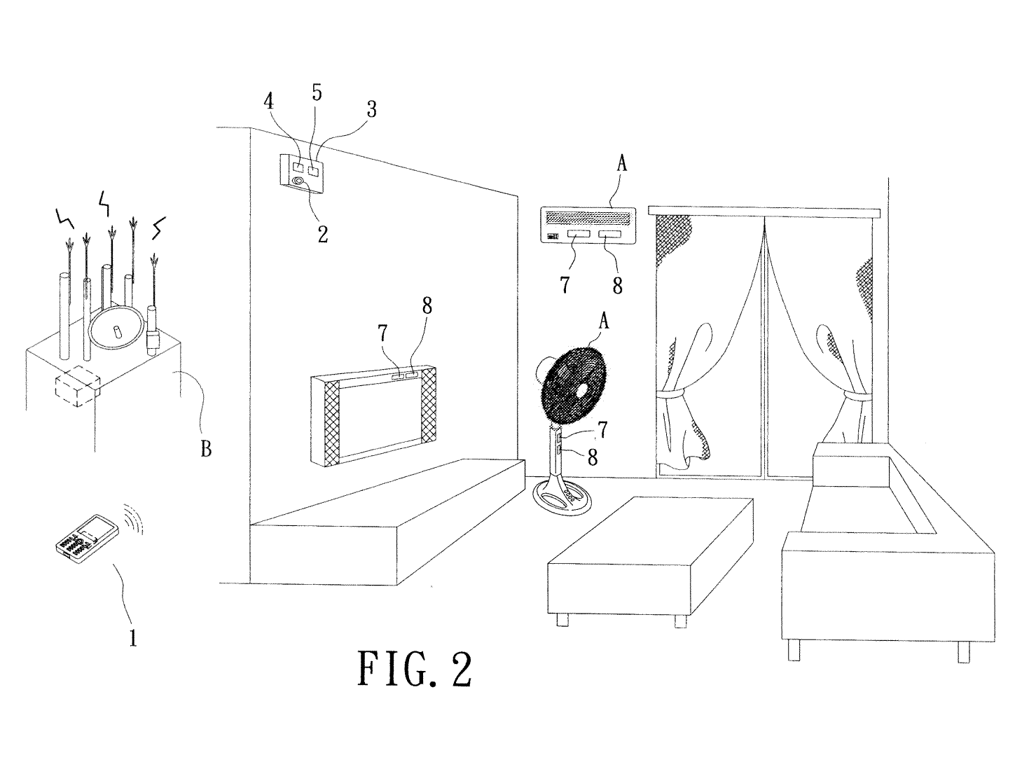

Refer to FIG. 1 and FIG. 2, a schematic drawing showing structure of a home use active remote encryption and switching device that sends remote images and information as well as controls on/off of at least one remote home appliance (A) by wireless communication is revealed. The home use active remote encryption and switching device includes at least one video mobile phone 1, a remote video recorder 2, a signal receiving interface 3, a digital signal processor 4, a central processing unit 5, a storage device 6, a sensor 7, and a receiver 8.

The video mobile phone 1 is a specific video mobile phone 1 that support 3G standard, and sends or receives encrypted signals by a wireless telecommunications system (B). The remote video recorder 2 is an image recording unit for video recording and monitoring of the home appliance (A). The signal receiving interface 3 is a remote receiver for sending or receiving the encrypted signals from the video mobile phone 1 by the wireless telecommunications system (B). The digital signal processor 4 is a processor that decrypts and modulates the encrypted signals received by the signal receiving interface 3. The central processing unit 5 receives images from the remote video recorder 2 and decrypted signals from the digital signal processor 4, and outputs audio/video signals 52 as well as switching signals 51. The audio/video signals 52 are sent to the signal receiving interface 3 for being sent to the specific video mobile phone 1. And the audio/video signals 52 can also be stored. As to the switching signals 51, they are sent to the home appliance (A). The storage device 6 receives the audio/video signals 52 from the central processing unit 5 and stores the audio/video signals 52. The sensor 7 is disposed in the home appliance (A) and is used for detecting an external condition of the home appliance (A) and sending sensing signals to the remote video recorder 2 so that the sensing signals together with images from the remote video recorder 2 are sent to the central processing unit 5. The receiver 8 is arranged at the home appliance (A) and is used for receiving the switching signals 51 from the central processing unit 5 so as to make the home appliance (A) run the switching signals 51.

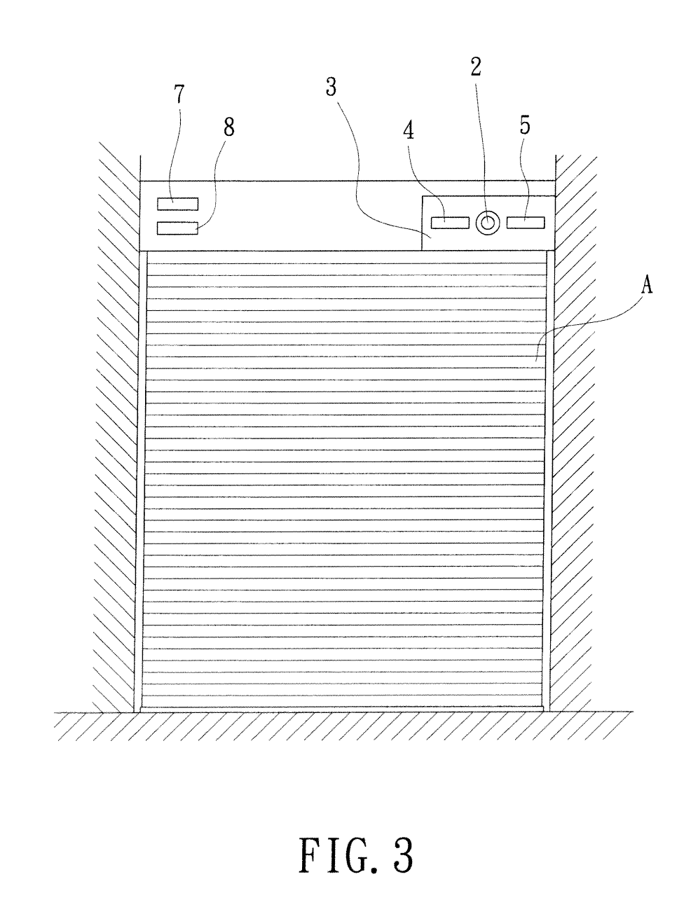

Refer to FIG. 2 and FIG. 3, the signal receiving interface 3 is disposed at home and a plurality of home appliances (A) is controlled and operated by the signal receiving interface 3 correspondingly. The signal receiving interface 3 gives specific permission to the user's video mobile phone 1 and has encryption settings at the same time. One signal receiving interface 3 is able to correspond to at least one video mobile phone 1 with permission.

As shown in FIG. 2, an embodiment of the present invention is used to turn on an air conditioner at home. When the user is in a hot outdoor environment and hoping to have air conditioning that makes him feel comfortable and cool, he can send a command through the specific video mobile phone 1 with permission to the signal receiving interface 3 by wireless communication. At the same time, input a password for the encryption so as to allow the signal receiving interface 3 receiving the signal. The encrypted signal received by the signal receiving interface 3 is decrypted and modulated by the digital signal processor 4. The decrypted signal is sent to the central processing unit 5 that outputs at least one audio/video signal 52 and at least one switching signal 51 according to the decrypted signal received. The switching signal 51 is sent to the air conditioner to be received by the receiver 8 disposed on the air conditioner. The receiver 8 executes the switching signal to turn on the air conditioner. After the air conditioner being turned on, the sensor 7 detects a condition of the surrounding environment and drives the remote video recorder 2 sending the audio/video signal 52 to the specific video mobile phone 1 by wireless communication. By the storage device 6 (memory storage device) of the video mobile phone 1, the audio/video signal 52 is stored or is sent to a cloud storage platform 6 of telecommunications service providers for storage. Moreover, the video mobile phone 1 corresponding to the signal receiving interface 3 can send messages in a single time, multiple times or continuingly so as to control and operate switches of a plurality of home appliances (A).

As shown in FIG. 3, another embodiment is used to turn on an electric rolling door for home use. When a bell of an electric rolling door rings, or the electric rolling door is manually damaged, the sensor 7 of the home appliance (A) checks the condition of the surrounding environment and sends a message, together with images recorded by the remote video recorder 2, to the central processing unit 5 for the decryption. Thus the audio/video signal 52 is transmitted to user's video mobile phone 1 by the wireless telecommunications system (B). According to the audio/video signal 52 received, the user can identify the person that rang the bell and determine whether the electric rolling door is open or not, or check that the electric rolling door is broken by burglars or contacted by animals accidentally. The user can use the video mobile phone 1 to execute the instructions. The video mobile phone 1 with specific permission connects to the signal receiving interface 3 by the wireless communication. A password for the encryption is simultaneously input so that the signal receiving interface 3 is allowed to receive the message. The encrypted signal received by the signal receiving interface 3 is decrypted and modulated by the digital signal processor 4. Next the decrypted signal is sent to the central processing unit 5 for audio/video signal 52 output and switching signal 51 output. The switching signal 51 is received and executed by the receiver 8 of the electric rolling door to turn on the electric rolling door and allow the person entering, or turn off the power of the electric rolling door to prevent burglars entering the home and call the police at the same time. Later the recorded images (audio/video signals 52) are sent to the specific video mobile phone 1 by wireless communication and are stored in the storage device 6 of the video mobile phone, or are further sent to a cloud storage service 6 provided by telecommunications service providers for storage.

Compared with techniques available now, the present invention has following advantages:
1. The home use active remote encryption and switching device of the present invention sends signals and executes commands by wireless communication. Thus the signals can be transmitted in the place where the mobile phone can receive signals. There is no need to use wired transmission media such as wires or cables that have bandwidth problems. Thus the construction cost of the telecom systems is effectively reduced.
2. Due to the home use active remote encryption and switching device of the present invention, users do not need to move long distances to reach the site and the travel time is much cut. Moreover, fuel cost and carbon emissions of vehicles are reduced so as to achieve energy savings and carbon reduction.
3. The home use active remote encryption and switching device of the present invention provides more convenient control and management of home appliances by a wireless remote control system. Thus the automatic control of home appliances is achieved.
4. By the connection between the user's video mobile phone and the home appliance (one is active and the other is passive) and wireless telecommunications that allow the signal receiving interface sending and receiving interactive signals, the commands are executed and related information is sent back actively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A home use active remote encryption and switching device that sends remote images and information as well as controls on/off of remote home appliances by wireless communication comprising:
at least one video mobile phone that is a specific video mobile phone for sending or receiving encrypted signals by a wireless telecommunications system;
a remote video recorder that is an image recording unit for video recording and monitoring of the home appliance;
a signal receiving interface that is a remote receiver for sending or receiving the encrypted signals from the video mobile phone by the wireless telecommunications system;
a digital signal processor that is a processor for decrypting and modulating the encrypted signals received by the signal receiving interface;
a central processing unit that receives images from the remote video recorder and decrypted signals from the digital signal processor, output audio/video signals to be stored and to the signal receiving interface for being further sent to the specific video mobile phone, and output switching signals to the home appliance;
a storage device that receives the audio/video signals from the central processing unit and stores the audio/video signals;
a sensor disposed in the home appliance, detecting an external condition of the home appliance and sending sensing signals to the remote video recorder so that the sensing signals together with images from the remote video recorder are sent to the central processing unit; and
a receiver arranged at the home appliance and receiving the switching signals from the central processing unit so as to make the home appliance execute the switching signals.

2. The device as claimed in claim 1, wherein the video mobile phone supports at least 3^{rd} generation of standards for mobile telecommunications and mobile phones services.

3. The device as claimed in claim 1, wherein the storage device is a memory storage device of the video mobile phone.

4. The device as claimed in claim 1, wherein the storage device is a cloud storage platform of telecommunications systems.
